(19) United States
(12) Patent Application Publication
(10) Pub. No.: US 2022/0349525 A1
(43) Pub. Date: Nov. 3, 2022

(54) FUELING STATION FOR SUPPLY OF LIQUID ORGANIC HYDROGEN CARRIERS AND METHOD OF OPERATION

(71) Applicant: The Claire Technologies Corporation, Danville, CA (US)

(72) Inventors: Paul A. Allinson, Danville, CA (US); Alan Klaassen, Kensington, CA (US); Curtis L. Munson, Oakland, CA (US); Steven F. Sciamanna, Orinda, CA (US); Charles R. Wilson, San Francisco, CA (US)

(73) Assignee: The Claire Technologies Corporation, Danville, CA (US)

(21) Appl. No.: 17/733,549

(22) Filed: Apr. 29, 2022

Related U.S. Application Data
(60) Provisional application No. 63/181,968, filed on Apr. 30, 2021.

(51) Int. Cl. F17C 7/02

(52) U.S. Cl. CPC F17C 7/02; F17C 2221/012; F17C 2270/0171; F17C 2227/0135; F17C 2265/032; F17C 2265/065; F17C 2250/0443; F17C 2227/0302; F17C 2227/0337; F17C 2227/0178; F17C 2223/0153

(57) ABSTRACT

Apparatus, methods and technologies are described for utilizing a liquid organic hydrogen carrier (LOHC) fueling station to supply fresh or hydrogen laden LOHC and to recover spent or hydrogen depleted LOHC liquid fuels from mobile vehicles and tanker trucks to support the use of LOHC as carbon-neutral hydrogen fuels to power vehicles, to generate and store electricity, to generate and capture hydrogen, and to replace the use of conventional hydrocarbon fuels while maintaining an overall carbon-neutral balance with respect to the environment. The disclosure includes apparatus, methods and technologies to resupply a modular LOHC fueling station, to store, dispense and recover LOHC fuels, and to transfer the LOHC liquid fuels while balancing displaced vapors to maintain an overall carbon-neutral environmental footprint.

### PRIORITY

This application claims the benefit of the priority of an earlier filed U.S. provisional patent application Ser. No. 63/181,968, entitled “Fueling Station For Supply of Liquid Organic Hydrogen Carriers and Method of Operation,” filed on Apr. 30, 2021, which is hereby incorporated in its entirety by reference herein.

### FIELD

This disclosure relates generally to a method for providing hydrogen to mobile vehicles such as trucks and cars for Carbon-Neutral Hydrogen (CNH) operation when a liquid organic hydrogen carrier is used. In an electric or motor vehicle, hydrogen may be combusted to provide energy, or the hydrogen may be fed to a fuel cell to generate electricity to power the vehicle. This disclosure includes a process for supplying hydrogen, carried in the form of fresh LOHC (Liquid Organic Hydrogen Carrier). The fresh LOHC may be subject to a catalytic dehydrogenation reaction to release the hydrogen for use. Alternatively, the fresh LOHC may be used as a liquid fuel for direct combustion, replacing traditional gasoline and diesel fuels. A by-product being a hydrogen-depleted or dehydrogenated organic carrier is also produced, referred to here as “spent” LOHC. The spent LOHC is stored on-board for recycle and rehydrogenation to make “fresh” LOHC for re-use, being hydrogen-enriched or hydrogenated to restore its labile hydrogen content.

More specifically, this disclosure relates to apparatus, methods and technologies to supply a mobile vehicle with fresh LOHC from a modular fueling station. The disclosure also relates to methods of returning spent LOHC to the fueling station from the mobile vehicle. The disclosure also relates to the methods of resupplying the fueling station with fresh LOHC from an LOHC tanker truck. The disclosure also relates to refilling the tanker truck with spent LOHC for return to a site for re-hydrogenation and re-use. The disclosure also relates to the conversion of conventional fueling stations, both gasoline and diesel, for use as LOHC fueling stations. The disclosure also relates to a fueling station configured in modular units and associated methods and processes that enable the separate and simultaneous storage, handling, dispensing and reception of fresh and spent LOHC fuels wherein the modular fueling station is operated in a manner to ensure an overall carbon-neutral environmental footprint by managing and controlling against the release of fuel and fuel vapors to the atmosphere.

### BACKGROUND

Systems employing battery storage to supply electricity for transportation needs are known and readily available. But large energy consumers such as long-haul trucks, trains and heavy earth-moving and other heavy-duty equipment that depend exclusively on batteries are limited in range, in operating capacity and in time by battery capacity, even though typically being in the kilowatt per hour (kWh) range and extended battery recharging time required. United States patent application publication No.: 2022/0109175A1 (“Allinson et al.”) discloses a method for powering vehicles and equipment for extended periods in a carbon-neutral process, utilizing an energy transfer system that can store power in the megawatt per hour (MWh) range which can be replenished in minutes thereby greatly extending the equipment's performance envelopes.

The method of Allinson et al. uses liquid organic hydrogen carriers or LOHC to supply hydrogen for on-board use. Many different molecules have been used or studied as LOHC materials, including such saturated cyclic compounds such as methylcyclohexane or dibenzyl toluene. Stated briefly, hydrogen is extracted from the LOHC in a catalytic dehydrogenation reaction. The hydrogen is then used as a fuel, or delivered to a fuel cell, such as a PEMFC (proton exchange membrane fuel cell) or SOFC (solid oxide fuel cell), where it is used to generate electricity to power an electric vehicle or hybrid electric vehicle. The spent LOHC is returned to a storage tank, ultimately for recycle, re-hydrogenation, and reuse.

The LOHC can be delivered, stored, and dispensed using existing equipment common to oil refineries, petrochemical plants, and current distribution pipelines to terminals.

Systems utilizing fuel cells for the generation of power are known and readily available, but they cannot currently operate in carbon-neutral (CN) mode utilizing LOHCs without a CN external power or heat supply.

Carbon-neutral systems utilizing hydrogen are known and readily available but generally require high pressure compression in the 10,000-psig region for storage and use in fuel cells.

This disclosure relates to the use of fueling stations to deliver LOHC to trucks and cars. The disclosure also relates to the methods of resupplying the fueling station with fresh LOHC. The disclosure also relates to the method and apparatus for conversion of conventional fueling stations, both gasoline and diesel, for use as LOHC fueling stations.

Allinson et al. further teaches the use of Carbon Neutral electricity generation to power electric vehicles.

What is needed, are apparatus, methods and technologies that enable the convenient dispensing of fresh LOHC and recovery of spent LOHC in a manner accessible to mobile vehicles comparable to existing fueling stations. One embodiment of the present disclosure is a Carbon Neutral Power Module (CNPM) that operates to supply electrical energy used by mobile devices. One embodiment of the CNPM comprises a first storage vessel for containing the recyclable LOHC prior to dehydrogenation, a second storage vessel for containing the unloaded aromatic substrate product, or spent LOHC, from dehydrogenation, a dehydrogenation reaction zone for generating hydrogen from recyclable R-LOHC, a hydrogen purification capability for preparing the hydrogen for electrochemical conversion and electricity generation, and a separation unit for separating unloaded aromatic substrate from dehydrogenation into a recycle liquid.

In another embodiment of the present disclosure, the CNPM includes two liquid storage vessels, a first storage vessel for containing the LOHC as delivered to the vehicle and a second storage vessel for receiving and containing the recycle liquid recovered from dehydrogenation termed spent LOHC. The recyclable R-LOHC and the spent LOHC are low vapor pressure liquids that may be stored in vessels that would be suitable for gasoline, kerosene, and diesel fuel storage, further including such existing vessels modified by the apparatus, methods and technology according to the present disclosure. In one embodiment, the first and the second storage vessels are independent of one another, or alternatively different vessels located separately in the vehicle. In another embodiment, the two storage vessels are combined into a single vessel, separated into two volumes within the storage vessel by a flexible bladder or a similar means that enables access to both the vapor space and liquid storage space of a single integrated vessel. In related embodiments, as LOHC is supplied to the vehicle and the recycle liquid spent LOHC is removed, the relative size of a first volume containing the LOHC decreases and that of a second volume containing the spent liquid spent LOHC increases. In a further related embodiment, a novel dual nozzle apparatus as disclosed herein may dispense fresh R-LOHC to the vehicle while simultaneously extracting spent liquid LOHC from the vehicle.

The present disclosure further relates to apparatus, methods and technology to supply the vehicle with LOHC by way of a fueling station. The present disclosure also relates to the methods of returning spent LOHC to the fueling station recovered from a vehicle. The present disclosure also relates to the methods of resupplying the fueling station with fresh LOHC from an LOHC tanker truck. The present disclosure also relates to refilling a tanker truck with spent LOHC for return to an originating site for re-hydrogenation and re-use. The present disclosure also relates to the conversion of conventional fueling stations, both gasoline and diesel, for use as LOHC fueling stations.

It may be mentioned that handling an LOHC, such as methylcyclohexane, is in some ways less problematic than handling gasoline. LOHC, unlike gasoline, does not include MTBE, ethanol, or other water soluble or partially soluble materials. Therefore, a spill is less of a threat to groundwater. Further, LOHC does not include highly volatile components, such as ethanol or pentane, which makes it more difficult to recover all associated vapors when handling a liquid fuel.

General embodiments of the present disclosure discussed herein include a fueling station for transferring Liquid Organic Hydrogen Carrier (LOHC) fuels to and from a mobile vehicle that has a fresh LOHC module consisting of: (i) a fresh LOHC storage tank; (ii) a first submersible pump within the fresh LOHC storage tank; (iii) a delivery conduit connecting the fresh LOHC storage tank and the first submersible pump capable of transferring fresh LOHC fuel from the fresh LOHC storage tank to a fuel dispenser during a first transfer operation; (iv) a fuel dispenser capable of transferring the fresh LOHC fuel to a mobile vehicle; (v) a vapor recovery system including a vapor vent conduit connected to a vapor vent located in the headspace of the fresh LOHC storage tank and the fuel dispenser for collecting fuel vapors released during the first transfer operation; and a spent LOHC module consisting of: (vi) a spent LOHC storage tank; (vii) a second submersible pump within the spent LOHC storage tank; (viii) a receiving conduit connecting the spent LOHC storage tank and the second submersible pump capable of transferring spent LOHC fuel from the mobile vehicle in a second transfer operation; and (ix) a vapor vent conduit connected to a vapor vent located in the headspace of the spent LOHC storage tank for collecting fuel vapors from the headspace of the spent LOHC storage tank during the second transfer operation.

In further embodiments, the fueling station may further be configured so that the fresh and spent LOHC modules are operated in a reverse manner to transfer in a first operation the fresh LOHC fuel from the fuel dispenser from a mobile vehicle to the fresh LOHC storage tank and independently in a second operation transfer the spent LOHC fuel to the fuel dispenser to a mobile vehicle; wherein the mobile vehicle has an onboard storage tank receptive to either the fresh or spent LOHC fuel.

In yet further embodiments, the fueling station includes a vapor condenser connected to a vapor recovery system for condensing LOHC fuel vapor to the corresponding condensed liquid LOHC fuel form of the LOHC fuel and returning the condensed liquid LOHC fuel to the corresponding LOHC storage tank to maintain an overall carbon-neutral transfer process by means of one or more liquid conduits associated with the vapor recovery system, and in alternative embodiments, the fueling may further include a flow controller and counter for controlling and measuring a volume of a LOHC fuel transferred to or transferred from the mobile vehicle.

In related embodiments, the vapor recovery system further comprises a vapor condenser for condensing LOHC fuel vapors vented from either LOHC storage tank configured to return the corresponding condensed liquid LOHC fuel to a LOHC storage tank.

Another embodiment contemplates an LOHC fueling station wherein a conventional gasoline or diesel fueling station has been converted to the handling of LOHC fuels by substituting one or more existing fuel storage tanks with either a fresh LOHC module or a spent LOHC module or both, and at least one vapor recovery system.

In some embodiments, the fuel station further includes an air or compressed gas inlet connected to at least one of the LOHC storage tanks; wherein air or compressed gas introduced to the gas inlet operates to maintain vapor pressure balance with the LOHC storage tank during a transfer of a liquid LOHC fuel to the corresponding LOHC storage tank; and wherein the vapor pressure operates to maintain a net carbon-neutral transfer process by means of a pressure-vacuum relief valve communicating with the air or compressed gas inlet.

In some embodiments, the fueling station accommodates mobile vehicles having a single onboard storage tank; wherein the onboard storage tank is configured to receive, store and dispense a LOHC fuel; wherein the onboard storage tank further hosts a vapor recovery system onboard the mobile vehicle that operates to balance the vapor pressure between the onboard storage tank and an external storage tank during a transfer operation of the LOHC fuel so as to prevent the release of fuel vapors to the environment in order to maintain an overall carbon-neutral process.

In other embodiments, the fueling station accommodates mobile vehicles having a first and second onboard storage tank; wherein the first onboard storage tank is configured to receive, store and dispense spent LOHC fuel; and wherein the second onboard storage tank is configured to receive, store and dispense fresh LOHC fuel.

In other embodiments, the mobile vehicle has an onboard vapor recovery system that operates to balance the vapor pressure between the first and second onboard storage tanks during a transfer operation so as to prevent the release of fuel vapors to the environment in order to maintain an overall carbon-neutral process.

In yet further embodiments, the mobile vehicle has an onboard storage tank configured to have: (i) an internal spent LOHC portion receptive to receive, store and dispense spent LOHC fuel; (ii) a fresh LOHC portion receptive to receive, store and dispense fresh LOHC fuel; and (iii) a partition system configured to separate the onboard storage tank into the internal spent and fresh LOHC portions; wherein the partition system is selected from a movable baffle, flexible baffle, moving piston, one of more flexible bladders configured with according means to enabling expansion and contraction in volume, and combinations thereof; and wherein the partition system maintains an overall constant volume while internally enabling the respective the spent LOHC portion and fresh LOHC portion to change volumes with respect to one another based on the volume of spent LOHC fuel and the volume of fresh LOHC fuel present within the onboard storage tank at any given time.

Further embodiments of the present disclosure include methods and processes for operating a LOHC fueling station for transferring LOHC fuel to and from a mobile vehicle in communication with the fueling station; wherein the transfer of the LOHC fuel is conducted in an overall carbon-neutral manner that prevents the release of any corresponding LOHC fuel vapors to the environment.

Embodied methods include the use of apparatus such as the disclosed vapor recovery system hosting a vapor condenser connected to the vapor recovery system for condensing LOHC fuel vapor to the corresponding condensed liquid LOHC fuel form of the LOHC fuel and returning the condensed liquid LOHC fuel to the corresponding LOHC storage tank to maintain an overall carbon-neutral transfer process by means of one or more liquid conduits associated with the vapor recovery system.

Embodied methods further include the use of the vapor recovery system further including an air or compressed gas inlet connected to at least one of the LOHC storage tanks; wherein air or compressed gas introduced to the gas inlet operates to maintain vapor pressure balance with the LOHC storage tank during a transfer of a liquid LOHC fuel to the corresponding LOHC storage tank; and wherein the vapor pressure operates to maintain a net carbon-neutral transfer process by means of a pressure-vacuum relief valve communicating with the air or compressed gas inlet.

Further embodied methods include using mobile vehicles hosting a vapor recovery system onboard the mobile vehicle that operates to balance the vapor pressure between the first and second onboard storage tanks during a transfer operation so as to prevent the release of fuel vapors to the environment in order to maintain an overall carbon-neutral process.

Methods include embodiments wherein the mobile vehicle has a first and second onboard storage tank; wherein the first onboard storage tank is configured to receive, store and dispense spent LOHC fuel; and wherein the second onboard storage tank is configured to receive, store and dispense fresh LOHC fuel, as well as wherein the mobile vehicle has an onboard storage tank configured to have: (i) an internal spent LOHC portion receptive to receive, store and dispense spent LOHC fuel; (ii) a fresh LOHC portion receptive to receive, store and dispense fresh LOHC fuel; and (iii) a partition system configured to separate the onboard storage tank into the internal spent and fresh LOHC portions; wherein the partition system is selected from a movable baffle, flexible baffle, moving piston, one of more flexible bladders configured with according means to enabling expansion and contraction in volume, and combinations thereof; and wherein the partition system maintains an overall constant volume while internally enabling the respective the spent LOHC portion and fresh LOHC portion to change volumes with respect to one another based on the volume of spent LOHC fuel and the volume of fresh LOHC fuel present within the onboard storage tank at any given time.

### BRIEF DESCRIPTION OF THE DRAWINGS

FIG. 1 illustrates one embodiment of a modular fueling station configured to dispense and receive a liquid LOHC fuel from a mobile vehicle.

FIG. 2 illustrates one embodiment of a modular fueling station configured to resupply a mobile vehicle while managing liquid-vapor balance.

FIG. 3 illustrates one embodiment of a modular fueling station configured for the recovery of spent LOHC from a mobile vehicle for recycle.

FIG. 4 illustrates one embodiment of a modular fueling station for providing LOHC fuel to a mobile vehicle having a moveable partition tank.

FIG. 5 illustrates one embodiment of a modular fueling station configured to resupply a LOHC station from a tanker truck having a movable partition.

### DETAILED DESCRIPTION

Described below are more detailed embodiments of processes and systems to deliver fresh or regenerated LOHC to a vehicle for the purpose of on-board generation of hydrogen, which, in turn may be used to generate electricity by use of a hydrogen fuel cell. Various embodiments of the disclosed processes and systems would also be used to simultaneously recover spent LOHC that has previously been used to release hydrogen. Further embodiments of this present disclosure may incorporate other related LOHC systems well known in the art, as well as a range of common hydrogenated refinery streams that may also be adapted for use as LOHC hydrogen carriers, but employing the further novel features of the present disclosure. Spent LOHC is a dehydrogenated form of the starting material, such as for example, but not limited to methylcyclohexane (MCH) as one suitable LOHC fuel material, the resulting spent LOHC being toluene which is the dehydrogenation product of MCH after extraction of hydrogen.

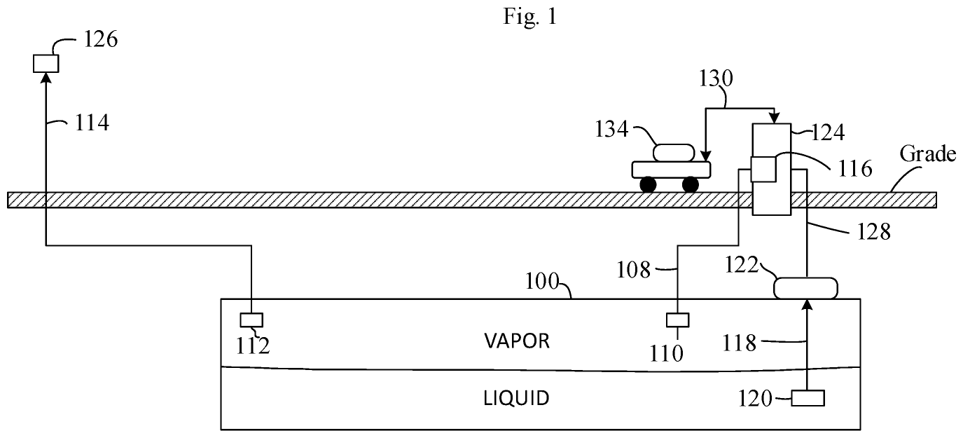

FIG. 1 illustrates an embodiment according to the present disclosure relating to a modular LOHC fueling station, including apparatus, methods and technologies used for vehicle refueling with fresh LOHC fuel at a fueling station or service facility modified to supply and recover an LOHC fuel. In general embodiments, the disclosed methods relate to the supply of fresh LOHC from a first storage container or tank to a onboard storage container or tank on a mobile vehicle or truck while controlling vapors generated in the headspace of the tanks to maintain equilibrium balance during the transfer while preventing the release of any LOHC vapor to the environment, in order to maintain an overall carbon-neutral footprint.

The modular LOHC fueling station includes an LOHC storage tank 100 for LOHC fuel storage. The LOHC storage tank 100 may in one embodiment be an elevated tank above grade, or alternatively as shown, located below the grade, or yet alternatively positioned on the grade. In one embodiment, liquid LOHC fuel is delivered by fuel supply pump 120 via a fuel supply conduit 118, through a containment chamber 122, through a fuel delivery conduit 128 and then through a dispenser 124 for delivery to a vehicle 134 via a fueling hose 130. In one embodiment, the fueling hose 130 is a coaxial hose that includes a first coaxial conduit 131 (not shown) for delivering fresh LOHC via a delivery nozzle 133 (not shown) to the vehicle 134 and a second coaxial conduit 132 (not shown) positioned coaxially with regard to the first coaxial conduit within the fueling hose 130 for conducting vapors via the delivery nozzle 133 from a fuel tank in the vehicle 134 to the dispenser 124.

As the fuel tank (not shown) in the vehicle 134 is filled, vapor in the headspace of the fuel tank is displaced. In one embodiment, this displaced vapor is removed via the second coaxial conduit 132 in the fueling hose 130 and returned to a vapor return module 110 located with LOHC storage tank 100 via vapor return conduit 108 with the aid of a vacuum-assist pump 116 located in the dispenser 124. In a related embodiment, fuel vapor in the LOHC storage tank 100 is vented from vapor vent module 112 through a vapor vent conduit 114 and captured in a vapor trap 126 to prevent release to the environment in support of maintaining a carbon-neutral fuel handling process according to the present disclosure. In general embodiments, the vapor handling apparatus are collectively described herein as a vapor recovery system consisting of the disclosed vapor conduits, vapor vents, vapor collection and vapor return modules, connecting conduits for both liquid and vapor forms of the LOHC fuels, control valves, and the like, and further including vapor condensers operating to convert gaseous fuel vapors to their corresponding liquid fuel forms.

In a related embodiment, the fueling hose 130 features two parallel internal conduits that serve a similar function to the coaxial conduits previously described, one of the parallel conduits configured for conveying an LOHC liquid fuel and the second parallel conduit configured to convey any displaced vapor or vapor released from the liquid LOHC fuel or vapor present in the headspace of a liquid LOHC supply tank, fuel tank, storage tank or the like.

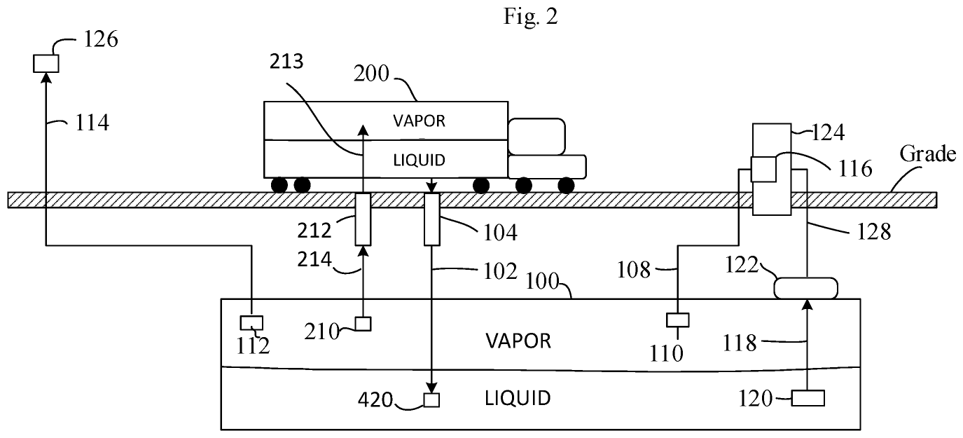

FIG. 2 illustrates general embodiments relating to apparatus and means for a mobile vehicle or truck to resupply or deliver fresh LOHC to a fueling station or service facility, where it may be stored for later transfer to another mobile vehicle or truck. In the embodiments disclosed below, the apparatus and means include steps to transfer fresh LOHC liquid from an on-board container or tank on the mobile vehicle or truck to a storage container or tank located on the premises of the modular LOHC fueling station, while managing vapor pressure differences during the transfer process so as to prevent the release of any fuel vapors so as to maintain an overall carbon-neutral transfer process.

FIG. 2 illustrates an embodiment relating to the capture and return of displaced vapors in a modular LOHC fueling station being re-supplied by an LOHC tanker truck 200 delivering LOHC fuel. As illustrated in FIG. 2, an LOHC tanker truck 200 is configured to supply liquid fuel by pumping or gravity feed via liquid supply conduit 102 by means of an optional overfill bucket 104. As LOHC storage tank 100 is refilled with liquid fuel, the displaced fuel vapors from the headspace of 100 are transferred to the vapor space in the LOHC tanker truck 200 by means of the vapor relief outlet 210 and vapor conduit 214 through vapor manifold 212 that accesses and transports LOHC vapors present above the LOHC liquid level in the LOHC storage tank 100 by means of an internally located vapor transport conduit 213. In this embodiment, LOHC fuel vapor that is forced out of the LOHC storage tank 100 is sent to and recovered into the vapor space within the LOHC tanker truck 200.

In another example embodiment as illustrated in FIG. 2, a liquid supply conduit 102 is used to fill the tank present on the LOHC tanker truck 200 using some suitable pumping means. A vapor conduit 214 communicating to a vapor manifold 212 is connected to the vapor transport conduit 213 associated with the LOHC tanker truck 200 to recover displaced vapors and return them to the LOHC storage tank 100. In this and related embodiments, the volumes of the liquid LOHC fuel and its associated vapor being moved between 100 and 200 as a connected system are approximately equal, and the liquid and vapor spaces of the connected system is maintained in equilibrium with balanced vapor pressures between maintained between them when connected.

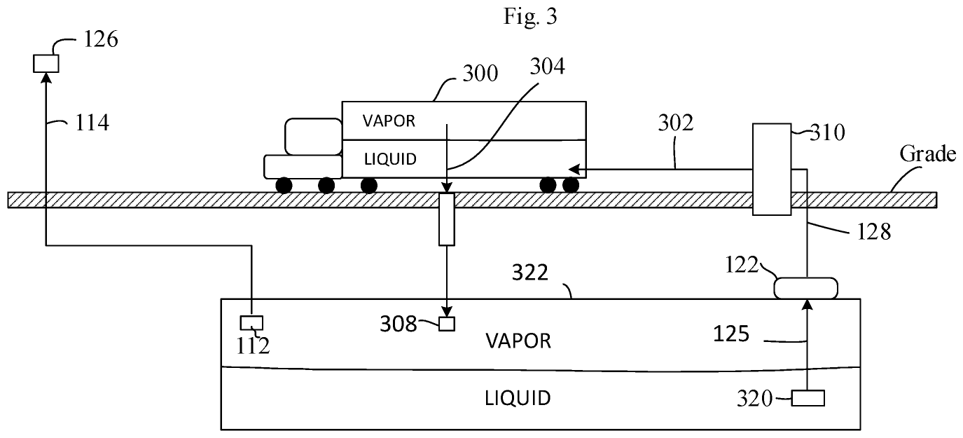

FIG. 3 illustrates some general embodiments relating to apparatus and methods to enable a mobile vehicle or tanker truck to collect spent LOHC from a modular LOHC fueling station or service facility for transport to a regeneration plant for regenerating the spent LOHC into fresh LOHC for re-use. In the embodiments disclosed below, the apparatus and means include steps to transfer spent LOHC liquid to an on-board container or tank on the mobile vehicle or truck from a storage container or tank located on the premises of the modular LOHC fueling station, while managing vapor pressure differences during the transfer process so as to prevent the release of any fuel vapors to maintain an overall carbon-neutral transfer process.

FIG. 3 illustrates an embodiment of the present disclosure configured for recovering spent LOHC for recycle. In the example embodied in FIG. 3, liquid fuel present in the spent LOHC storage tank 322 is spent LOHC that is available for removal by means of transfer to the tanker truck 300 for recycle and reuse. In one embodiment, a submersible pump 320 transports the liquid through spent LOHC delivery conduit 125 and into containment chamber 122. A flow controller and meter module 310 are installed to control the liquid flow by means of fuel transfer hose 302 into the tanker truck 300. Displaced vapor in the tanker truck 300 flows through a vapor return line 304 to the spent LOHC storage tank 322 through vapor return port 308 to maintain volume balance and prevent release of fuel vapors. To maintain pressure balance, fuel vapor in the spent LOHC storage tank 322 may also in a related embodiment be vented from vapor vent module 112 through vapor vent conduit 114 and captured in vapor trap 126.

In alternative embodiments wherein a tanker truck delivering fresh LOHC features only a single onboard tank, the fresh LOHC is delivered in a first step to an appropriate storage tank and the empty tanker truck is then refilled with spent LOHC in a second step. In an alternate embodiment, it is also possible to use a tanker truck featuring a second onboard tank, with a first tank containing fresh LOHC and the second tank initially being empty so as to provide a means to retrieve spent LOHC for recovery and regeneration of fresh LOHC. In related embodiments, the headspace volumes of the first and second tanks are in communication with one another either directly, or connected by means of a passive pressure equalization value, or gas pump or the like with a pressure sensing means to measure vapor pressures in the tanks or differential vapor pressures between the onboard tanks so as to enable the gas pump to adjust or equalize vapor pressures between the two onboard tanks. In further closely related embodiments, a communication means such as described herein above is further employed to control vapors and to sense and adjust fuel vapor pressures between the one or more onboard tanks and either a receiving tank or a supply tank holding or receptive to either fresh or spent LOHC fuel during a transfer process between a mobile vehicle or tanker truck and the LOHC refueling station according to the present disclosure.

In embodiments featuring tanker trucks with two onboard tanks, the two steps of delivery and recovery as described herein can then be done simultaneously while the tanker truck is located and communicating with the LOHC fuel handling facility as disclosed. In further embodiments, it is also possible to use a modified tanker truck with a single tank that alternatively features a movable partition that moves in response to the relative amount of spent and fresh LOHC present therein. In one example embodiment featuring a movable barrier or partition means, fresh LOHC is drained from the tanker truck from the space located on one side of the partition while spent LOHC is filled into the same tank into space located on the other side of the partition. In further embodiments, the partition system or moveable partition means includes, but is not limited to a movable baffle, flexible baffle, moving piston, one of more flexible bladders configured with according means to enabling expansion and contraction in volume, and combinations thereof capable of adjusting the relative volumes of two independent partition volumes within a tank to hold and separate two different liquids from one another without cross-mixing and further capable of adjusting the relative volumes of each of the two different liquids in response to either one of the liquids being added to or removed from its respective portion of the storage tank during a transfer operation.

With a movable partition or similar partitioning means present within a single onboard tank, filling of one external storage tank while emptying a second external storage tank can occur simultaneously, and in related alternative embodiments, filling of one fuel station receiving tank while dispensing from a second fuel station supply tank can also occur simultaneously, significantly reducing the amount of time necessary to fill, swap or supply a desired volume of spent and fresh LOHC liquids between a mobile vehicle and tanker truck. In related embodiments, the vapor pressure in the tanks can be monitored and controlled by means of the various apparatus, valves, pumps and vapor communication and collection means as disclosed herein to maintain either a desired pressure differential to help transfer the liquid fuel or an equilibrium in pressures balanced to prevent vapor lock or excessive pressure buildup that would otherwise require the unwanted venting of fuel vapors to the atmosphere.

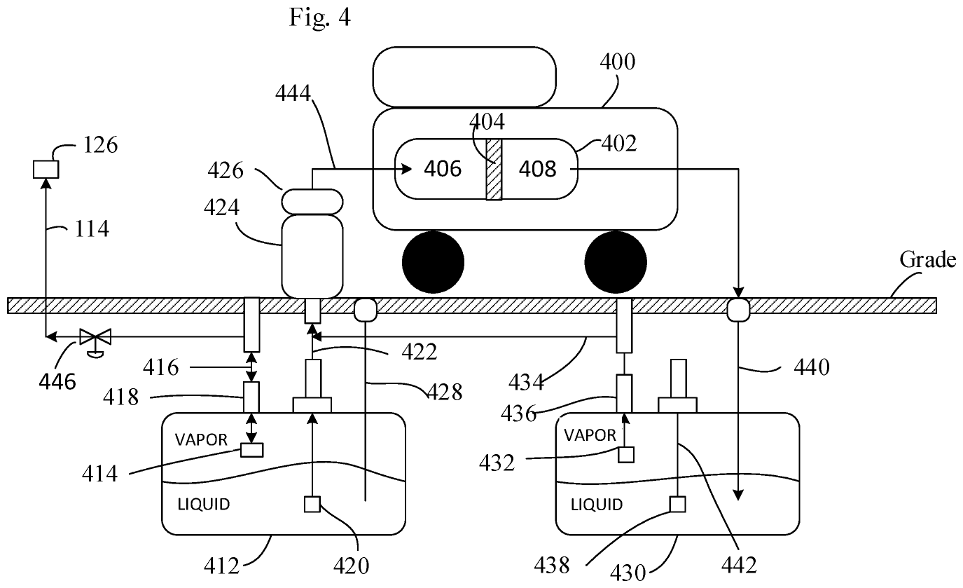

FIG. 4 illustrates general embodiments of the present disclosure relating to a modular LOHC fueling station or service facility having apparatus enabling the simultaneous transfer of spent LOHC and fresh LOHC between containers and storage tanks located on a vehicle, while managing vapor pressure differences during the transfer process so as to prevent the release of any fuel vapors to maintain an overall carbon-neutral transfer process, including a vapor trap to prevent the escape of fuel vapors to the environment, or alternatively a condenser for liquifying fuel vapors for return to an appropriate storage container.

FIG. 4 illustrates one embodiment of a vehicle 400 with a single vehicle fuel tank 402 having a movable partition 404 for storing LOHC fuel for vehicle use and for storing spent LOHC for recycle and reuse. Using a single tank with a movable partition reduces weight and volume needed to contain the fuel and byproduct, and in further embodiments enables the elimination of headspace so as to prevent vapors forming over the liquid fuel. In the embodiment shown in FIG. 4, the partition creates two volumes or spaces within the single vehicle fuel tank 402. As the fresh LOHC enters from a first or left side of the movable partition 404, fresh LOHC tank portion 406 expands in volume, resulting in movement of 404 in a direction to the right as illustrated, so that it moves and displaces a similar volume of spent LOHC present in the spent LOHC tank portion 408 from the second or left side of the movable partition 404. Thus, spent LOHC is dispensed from the vehicle 400 while fresh LOHC is supplied to the vehicle, simultaneously and without the requirement of monitoring or controlling fuel vapors within the single vehicle fuel tank 402 located aboard the vehicle 400. In a closely related embodiment, the filling and dispensing process can be reversed, so as to enable a vehicle 400 with the single vehicle fuel tank 402 to dispense fresh LOHC from one side of the moveable partition 404 while receiving spent LOHC into the second side of the moveable partition 404 simultaneously.

Movement of the partition 404 as it moves to accommodate the increased volume of spent LOHC or the decreased volume of fresh LOHC, or in embodiments in which the process is reversed, does not create fuel vapors as happens in a conventional fuel tank which is rigid and therefor results in the creation of a headspace within the tank that fills with fuel vapors. Although use of a single tank with a movable partition has multiple advantages in reducing weight and volume, and the need for onboard or external vapor pressure control of the onboard tank itself, control of fuel vapors in these alternate embodiments requires control of the fuel vapors in the supply and recovery tanks located at the fueling station.

Thus, a means to monitor, control, recover and recycle fuel vapors present in the supply and receiving tanks holding fresh and spent LOHC liquid fuels is required, particularly with a means to prevent any release of the fuel vapors from the LOHC transfer station so that the transfer process can be maintained under rigid carbon-neutral conditions that maintain environmental integrity.

Accordingly, in one embodiment as illustrated in FIG. 4, no fuel vapors are generated within the vehicle fuel tank 402 during movement of spent or fresh LOHC into and out from the vehicle fuel tank 402, and thus no fuel vapor pressure otherwise generated on the onboard vehicle can be used to balance the volume of material removed from the storage tank as in conventional gasoline loadings. Accordingly, an external vapor pressure balancing system, apparatus and means are needed to assist during liquid LOHC fuel transfer with a vehicle 400 that uses a vehicle fuel tank 402 with a moveable partition 404 as illustrated in FIG. 4 in order to maintain an overall carbon-neutral process. In one embodiment fresh LOHC is pumped from the fresh LOHC storage tank 412 through delivery conduit 422 by means of a submersible pump 420 through the dispenser 424 and flow controller and counter unit 426, and then through a fuel delivery conduit 444 to the fresh LOHC tank portion 406 located on the vehicle 400. Incoming fresh LOHC motivates the flow of spent LOHC from the spent LOHC tank portion 408 through the spent LOHC recovery conduit 440 and into a receptive spent LOHC storage tank 430. Vapor will be displaced from the spent LOHC storage tank 430 through the vapor vent conduit 434 via vapor vent 432 through the vapor vent module 436. This vapor may then be channeled to the fresh LOHC storage tank 412 via delivery conduit 422 to help equilibrate vapor pressure between 412 and 430. In alternative embodiments, the fresh LOHC storage tank 412 can be connected via a valve similar to 446 to the vapor trap 126 via vapor vent conduit 114, or via a similar but separate second vapor vent conduit to and a second vapor trap (not shown). The vapor trap 126 may be any suitable condenser, including a condenser using cooling water as the heat transfer medium which will be particularly effective due to the high boiling point of most LOHC materials and their corresponding chemical constituents and components compared to traditional fuels such as gasoline, diesel and ethanol-containing fuels all having lower boiling points and flash points. In other related embodiments, condenser-chiller combinations are suitable as well that do not require chilled water, but employ their own internal chilling or heat transfer means including liquid heat transfer, thermo-electric and thermionic means. In further embodiments, the condensers are modified or selected to specifically handle the higher boiling point of the LOHC fuels and their respective chemical components in either the fresh or spent LOHC forms of the fuel. In yet other embodiments, the vapor trap 126 can be a compressor that compresses fuel vapors back into the form of the corresponding liquid LOHC fuel.

In further embodiments illustrated in FIG. 4, as fresh LOHC is pumped from the fresh LOHC storage tank 412 to the fresh LOHC tank portion 406 in the vehicle 400, a vapor imbalance may develop in the fresh LOHC storage tank 412 and between the two tanks. The pressure balance may be restored by means of air introduced by way of the pressure-vacuum release valve 446, when it is set in communication with the atmosphere when atmospheric pressure exceeds the vapor pressure within 412. Alternatively, excess prior recovered LOHC vapor present in the vapor trap 126 can be introduced into the vapor headspace portion of 412 by means of the vapor vent conduit 114 through the pressure-vacuum release valve 446 connecting through 416 and 418 to the fresh LOHC storage tank 412. In yet an alternative embodiment in the event of higher vapor pressure within 412, excess fuel vapors may be channeled through the vapor vent 414 to the vapor vent module 418, then through the vapor vent line 416 to the vapor vent conduit 114 when the pressure-vacuum release valve 446 is set in communication with the vapor vent conduit 114 and captured by the vapor trap 126. In an alternative embodiment, bottled or pressurized nitrogen gas may be introduced via the pressure-vacuum release valve 446 into 412 by a similar means as disclosed hereinabove for introducing air.

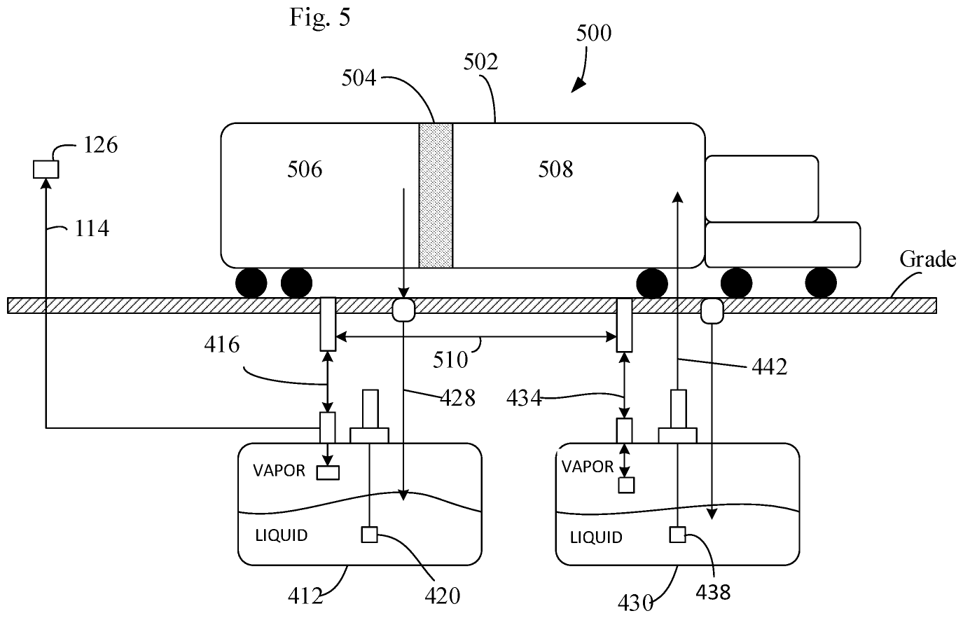

FIG. 5 illustrates general embodiments of the present disclosure relating to a modular LOHC fueling station or service facility having apparatus enabling the simultaneous transfer of spent LOHC and fresh LOHC between containers and storage tanks located on a vehicle, while managing vapor pressure differences during the transfer process so as to prevent the release of any fuel vapors to maintain an overall carbon-neutral transfer process, including a vapor trap to prevent the escape of fuel vapors to the environment, or alternatively a condenser for liquifying fuel vapors for return to an appropriate storage container.

FIG. 5 illustrates an embodiment, including a tanker truck 500 for delivering fresh LOHC fuel from the truck to a fresh LOHC storage tank 412 through fresh LOHC delivery conduit 428 and for receiving spent LOHC from spent LOHC storage tank 430 through removal conduit 442. The tanker truck in this embodiment has a fuel storage tank 502 fitted with a movable partition 504 that divides the interior volume of 502 into a fresh LOHC tank portion 506 and a spent LOHC tank portion 508. As fresh LOHC fuel is removed from the tanker truck from the fresh LOHC tank portion 506 to the receptive fresh LOHC storage tank 412 through fresh LOHC delivery conduit 428, an approximately equal volume of spent LOHC is transferred to the spent LOHC tank portion 508 onboard the tanker truck from the spent LOHC storage tank 430 using submersible pump 438 via removal conduit 442, wherein the movable partition 504 is motivated to move to accommodate the decreased volume of fresh LOHC in 506 and the increased volume of spent LOHC in 508. To balance the pressure from vapor generated in the two respective tanks, a pressure balancing conduit 510 is employed that connects the vent vapor line 416 of the fresh LOHC storage tank 412 to the vapor vent conduit 434 of the spent LOHC storage tank 430, enabling a liquid volume and vapor pressure balance (combined hydrodynamic balance) as fresh LOHC is pumped into 412 and spent LOHC is pumped out of 430. Even in the event that a small amount of fresh LOHC may be mixed into the spent LOHC due to residual volume of fuel that may be present in the transfer conduits, this volume will be fairly negligible as the internal volume of the various conduits (416, 434) are very small compared to the volume of fuel transferred and the volume of the respective storage tanks (412, 430) and the volume of the tanker truck fuel storage tank 502 and its respective fresh LOHC tank portion 506 and a spent LOHC tank portion 508. During transfer of the liquid LOHC fuels, any excess vapors due to higher vapor pressure within fresh LOHC storage tank 412 may also be vented via vapor vent conduit 114 to vapor trap 126, and excess vapors within the spent LOHC storage tank 430 may be vented through 434 to 416 via pressure balancing conduit 510 to the headspace in fresh LOHC storage tank 412, or alternatively vented through 434 to 126 via pressure balancing conduit 510, through 416 to 114 and then to vapor trap 126.

In related embodiments, either or both of the fresh LOHC delivery conduit 428 and removal conduit 442 may include an in line flow controller and counter unit 426 (not shown) to measure and control the volume of fresh and spent LOHC fuel being transferred, and in alternative embodiments, the volumes compared so that any discrepancy in volumes accounted for in order to detect unwanted leaks that would otherwise compromise the net carbon-neutral transfer of LOHC fuels during a transfer operation between a mobile vehicle, tanker truck and the LOHC transfer station according to the various embodiments of the disclosure as described and illustrated in the figures.

APPENDIX

| Description | FIG. Element Label |
|---|---|
| LOHC storage tank | 100 |
| liquid supply conduit | 102 |
| overfill bucket | 104 |
| vapor return conduit | 108 |
| vapor return module | 110 |
| vapor vent module | 112 |
| vapor vent conduit | 114 |
| vacuum-assist pump | 116 |
| fuel supply conduit | 118 |
| fuel supply pump | 120 |
| containment chamber | 122 |
| dispenser | 124 |
| spent LOHC delivery conduit | 125 |
| vapor trap | 126 |
| fuel delivery conduit | 128 |
| fueling hose | 130 |
| first coaxial conduit | 131 |
| second coaxial conduit | 132 |
| delivery nozzle | 133 |
| vehicle | 134 |
| LOHC tanker truck | 200 |
| vapor relief outlet | 210 |
| vapor manifold | 212 |
| vapor transport conduit | 213 |
| vapor conduit | 214 |
| tanker truck | 300 |
| fuel transfer hose | 302 |
| vapor return line | 304 |
| vapor return port | 308 |
| flow controller and meter module | 310 |
| submersible pump | 320 |
| spent LOHC storage tank | 322 |
| vehicle | 400 |
| vehicle fuel tank | 402 |
| movable partition | 404 |
| fresh LOHC tank portion | 406 |
| spent LOHC tank portion | 408 |
| fresh LOHC storage tank | 412 |
| vapor vent | 414 |
| vapor vent line | 416 |
| vapor vent module | 418 |
| submersible pump | 420 |
| delivery conduit | 422 |
| dispenser | 424 |
| flow controller and counter unit | 426 |
| fresh LOHC delivery conduit | 428 |
| spent LOHC storage tank | 430 |
| vapor vent | 432 |
| vapor vent conduit | 434 |
| pressure-vacuum relief valve | 436 |
| submersible pump | 438 |
| spent LOHC recovery conduit | 440 |
| removal conduit | 442 |
| fuel delivery conduit | 444 |
| pressure vacuum release valve | 446 |
| tanker truck | 500 |
| fuel storage tank | 502 |
| movable partition | 504 |
| fresh LOHC tank portion | 506 |
| spent LOHC tank portion | 508 |
| pressure balancing conduit | 510 |

What is claimed is:

1. A fueling station for transferring Liquid Organic Hydrogen Carrier (LOHC) fuels to and from a mobile vehicle comprising:
a) a fresh LOHC module consisting of:
i) a fresh LOHC storage tank;
ii) a first submersible pump within said fresh LOHC storage tank;
iii) a delivery conduit connecting said fresh LOHC storage tank and said first submersible pump capable of transferring fresh LOHC fuel from said fresh LOHC storage tank to a fuel dispenser during a first transfer operation;
iv) a fuel dispenser capable of transferring said fresh LOHC fuel to said mobile vehicle;
b) a vapor recovery system including a vapor vent conduit connected to a vapor vent located in the headspace of said fresh LOHC storage tank and said fuel dispenser for collecting fuel vapors released during said first transfer operation;
c) a spent LOHC module consisting of:
i) a spent LOHC storage tank;
ii) a second submersible pump within said spent LOHC storage tank;
iii) a receiving conduit connecting said spent LOHC storage tank and said second submersible pump capable of transferring spent LOHC fuel from said mobile vehicle in a second transfer operation; and
iv) a vapor vent conduit connected to a vapor vent located in the headspace of said spent LOHC storage tank for collecting fuel vapors from said headspace of said spent LOHC storage tank during said second transfer operation.

2. The fueling station of claim 1, wherein said fresh and spent LOHC modules are operated in a reverse manner to transfer in a first operation said fresh LOHC fuel from said fuel dispenser from a mobile vehicle to said fresh LOHC storage tank and independently in a second operation transfer said spent LOHC fuel to said fuel dispenser to a mobile vehicle; wherein said mobile vehicle has an onboard storage tank receptive to either said fresh or spent LOHC fuel.

3. The fueling station of claim 1, wherein said mobile vehicle is selected from an electric vehicle, a motor vehicle and a tanker truck having one or more liquid fuel storage tanks onboard receptive to said fresh and spent LOHC fuels.

4. The fueling station of claim 1, further comprising a vapor condenser connected to said vapor recovery system for condensing LOHC fuel vapor to the corresponding condensed liquid LOHC fuel form of the LOHC fuel and returning said condensed liquid LOHC fuel to the corresponding LOHC storage tank to maintain an overall carbon-neutral transfer process by means of one or more liquid conduits associated with said vapor recovery system.

5. The fueling station of claim 1, further comprising a flow controller and counter for controlling and measuring a volume of a LOHC fuel transferred to or transferred from said mobile vehicle.

6. The fueling station of claim 1, wherein said vapor recovery system further comprises a vapor condenser for condensing LOHC fuel vapors vented from either LOHC storage tank configured to return the corresponding condensed liquid LOHC fuel to a LOHC storage tank.

7. The fueling station of claim 1, wherein a conventional gasoline or diesel fueling station has been converted to the handling of LOHC fuels by substituting one or more existing fuel storage tanks with either a fresh LOHC module or a spent LOHC module or both, and at least one vapor recovery system.

8. The fueling station of claim 1, further comprising an air or compressed gas inlet connected to at least one of said LOHC storage tanks; wherein air or compressed gas introduced to said gas inlet operates to maintain vapor pressure balance with said LOHC storage tank during a transfer of a liquid LOHC fuel to said corresponding LOHC storage tank; and wherein said vapor pressure operates to maintain a net carbon-neutral transfer process by means of a pressure-vacuum relief valve communicating with said air or compressed gas inlet.

9. The fueling station of claim 4 or claim 6, wherein said vapor condenser is selected from a vapor condenser using chilled water, heat transfer liquid, thermo-electric and thermionic means for cooling, and combinations thereof; wherein said vapor condenser is further configured to condense the higher boiling components present in said LOHC fuels in an overall carbon-neutral process with respect to the environment.

10. The fueling station of claim 1, wherein said mobile vehicle has a single onboard storage tank; wherein said onboard storage tank is configured to receive, store and dispense a LOHC fuel; wherein said onboard storage tank further hosts a vapor recovery system onboard said mobile vehicle that operates to balance the vapor pressure between said onboard storage tank and an external storage tank during a transfer operation of said LOHC fuel so as to prevent the release of fuel vapors to the environment in order to maintain an overall carbon-neutral process.

11. The fueling station of claim 1, wherein said mobile vehicle has a first and second onboard storage tank; wherein said first onboard storage tank is configured to receive, store and dispense spent LOHC fuel; and wherein said second onboard storage tank is configured to receive, store and dispense fresh LOHC fuel.

12. The fueling station of claim 11, wherein said mobile vehicle further hosts a vapor recovery system onboard said mobile vehicle that operates to balance the vapor pressure between said first and second onboard storage tanks during a transfer operation so as to prevent the release of fuel vapors to the environment in order to maintain an overall carbon-neutral process.

13. The fueling station of claim 1, wherein said mobile vehicle has an onboard storage tank configured to have:
a) an internal spent LOHC portion receptive to receive, store and dispense spent LOHC fuel;
b) a fresh LOHC portion receptive to receive, store and dispense fresh LOHC fuel; and
c) a partition system configured to separate said onboard storage tank into said internal spent and fresh LOHC portions;
wherein said partition system is selected from a movable baffle, flexible baffle, moving piston, one of more flexible bladders configured with according means to enabling expansion and contraction in volume, and combinations thereof; and
wherein said partition system maintains an overall constant volume while internally enabling the respective said spent LOHC portion and fresh LOHC portion to change volumes with respect to one another based on the volume of spent LOHC fuel and the volume of fresh LOHC fuel present within said onboard storage tank at any given time.

14. A method of operating a fueling station according to claim 1 for transferring Liquid Organic Hydrogen Carrier (LOHC) fuel to and from a mobile vehicle in communication with said fueling station; wherein the transfer of said LOHC fuel is conducted in an overall carbon-neutral manner that prevents the release of any corresponding LOHC fuel vapors to the environment.

15. The method of claim 14, wherein said vapor recovery system further includes a vapor condenser connected to said vapor recovery system for condensing LOHC fuel vapor to the corresponding condensed liquid LOHC fuel form of the LOHC fuel and returning said condensed liquid LOHC fuel to the corresponding LOHC storage tank to maintain an overall carbon-neutral transfer process by means of one or more liquid conduits associated with said vapor recovery system.

16. The method of claim 15, wherein said vapor condenser is selected from a vapor condenser using chilled water, heat transfer liquid, thermo-electric and thermionic means for cooling, and combinations thereof; wherein said vapor condenser is further configured to condense the higher boiling components present in said LOHC fuels.

17. The method of claim 16, wherein said vapor recovery system further comprises an air or compressed gas inlet connected to at least one of said LOHC storage tanks; wherein air or compressed gas introduced to said gas inlet operates to maintain vapor pressure balance with said LOHC storage tank during a transfer of a liquid LOHC fuel to said corresponding LOHC storage tank; and wherein said vapor pressure operates to maintain a net carbon-neutral transfer process by means of a pressure-vacuum relief valve communicating with said air or compressed gas inlet.

18. The method of claim 14, wherein said mobile vehicle further hosts a vapor recovery system onboard said mobile vehicle that operates to balance the vapor pressure between said first and second onboard storage tanks during a transfer operation so as to prevent the release of fuel vapors to the environment in order to maintain an overall carbon-neutral process.

19. The method of claim 14, wherein said mobile vehicle has a first and second onboard storage tank; wherein said first onboard storage tank is configured to receive, store and dispense spent LOHC fuel; and wherein said second onboard storage tank is configured to receive, store and dispense fresh LOHC fuel.

20. The method of claim 14, wherein said mobile vehicle has an onboard storage tank configured to have:
a) an internal spent LOHC portion receptive to receive, store and dispense spent LOHC fuel;
b) a fresh LOHC portion receptive to receive, store and dispense fresh LOHC fuel; and
c) a partition system configured to separate said onboard storage tank into said internal spent and fresh LOHC portions;
wherein said partition system is selected from a movable baffle, flexible baffle, moving piston, one of more flexible bladders configured with according means to enabling expansion and contraction in volume, and combinations thereof; and
wherein said partition system maintains an overall constant volume while internally enabling the respective said spent LOHC portion and fresh LOHC portion to change volumes with respect to one another based on the volume of spent LOHC fuel and the volume of fresh LOHC fuel present within said onboard storage tank at any given time.
